(19) United States
(12) Patent Application Publication
(10) Pub. No.: US 2010/0040758 A1
(43) Pub. Date: Feb. 18, 2010

(54) INTEGRATED PRODUCTION OF PHYTOCHEMICAL RICH PLANT PRODUCTS OR ISOLATES FROM GREEN VEGETATION

(76) Inventors: Chitra Vasant Savngikar, Maharashtra (IN); Vasant Anantrao Savangikar, Maharashtra (IN)

Correspondence Address: THE NATH LAW GROUP, 112 South West Street, Alexandria, VA, 22314, US

(21) Appl. No.: 12/448,600

(22) PCT Filed: Dec. 27, 2007
(86) PCT No.: PCT/IN2007/000611

§ 371 Date: Jun. 26, 2009

(30) Foreign Application Priority Data
Dec. 28, 2006 (IN) 2070/MUM/2006

(51) Int. Cl. A23D 7/04; A23D 7/005

(52) U.S. Cl. 426/602; 426/431; 426/392

(57) ABSTRACT

Invention provides improvement in process of green crop fractionation to provide a route for production of novel phytochemical compositions or ingredients containing natural products contained in green plant material. Primary products of green crop fractionation produced in conventional process are fractionated further by using processes of oil extraction, aqueous acid extraction, aqueous alkali extraction, solvent extraction or are modified further in their form leading to products that are enriched in either oil soluble phytochemicals or water soluble phytochemicals. Most of these products can be used for human consumption directly or as an ingredient of a composition with a minimal further processing. Choice exists of using a process that totally avoids use of volatile organic solvents.

### TECHNICAL FIELD

The invention pertains to products of chemicals produced by green vegetation for prophylactic or therapeutic prevention and treatment of various diseases and disorders; and a process for producing the said products.

### BACKGROUND OF INVENTION

It is being widely recognized that phytochemicals, i.e. chemicals present in plants have wide variety of uses that also includes as a very credible source of Plant Actives wherein products of isolates or concentrates or fractions of plant material rich in a phytochemical or a group of phytochemicals which provide satisfaction of a wide range of human needs including treating or preventing several diseases and disorders, cosmetic applications, consumer products and the like.

Some illustrative examples of useful Plant Actives and their raw material sources are as follows.

Carotenoids, Polyphenols and flavonols are known to be useful against a number of disorders. Processes used for extraction are aqueous or organic solvent from raw materials as like marigold flowers, Dunciniella alga green plant material, from tea leaves, from fruit juice, particularly berries, grapes and like. Isoflavones are known to have estrogenic action are known to be found in soybean. Tocopherols are extracted by solvent extraction from edible oils, like palm oil. Similarly, dietary fiber is known to provide a remedy or prevention for hypercholesterolemia, colonic cancer, constipation and is commercially available from. psyllium seed coat, rice bran, wheat bran and the like. Chlorophylls are known for their antibiotic and deodorant properties and are conventionally prepared from algae, including Dunciniella alga.

Thus, phytochemicals and products rich in them have a huge potential requirement, provided enough of them could be produced. However, the diverse types of phytochemicals need equally diverse raw materials for production, and each raw material has its own exclusive process of production. It is has not been found possible so far to envisage one single integrated process of production, which shall produce these diverse phytochemicals preferably from a single raw material source.

In fact, if not all the phytochemicals mentioned above, many of them covering most of the uses mentioned above, and also useful for additional uses in cosmetics, nutrition, consumer products and the like, are produced by green leafy vegetation. Illustrative list includes carotenes, xanthophylls, alpha tocopherol, polyphenols, fiber, chlorophylls, phytosterols, phytohormones, quinones including Coenzyme Q, polyunsarurated fatty acids including omega 3 fatty acid like alpha linolenic acid and the like, including secondary metabolites like saponins which are plant species specific. But these phytochemicals are present in such a dilute quantity, and the green leafy vegetation itself having about 80% water in it, that green leafy crop is always regarded as one of the most poor sources for these phytochemicals and unless a phytochemical is exceptionally rich, such as polyphenols from tea leaves, where too only one product is produced, no one came out so far with a process to produce phytochemicals or products rich in phytochemicals from green leafy vegetation. If such a process could be enabled and made available, green leafy vegetation is a kind of raw material which can be produced in plenty in short time from a wide number of herbaceous plant species and this shall provide a large reservoir of production of phytochemicals of pharmaceutical, neutraceutical, cosmaceutical importance.

The best known process and products involving use of green leafy vegetation as a raw material for production process is widely known as Green Crop Fractionation (GCF). GCF envisages a process in which fresh green vegetation/crop is macerated into a pulp, the pulp pressed to separate juice fraction from fibrous residue fraction, the juice is further treated to separate it further into at least one water insoluble essentially fiber free high protein concentrate (leaf protein concentrate, or leaf nutrient concentrate (LPC or LNC) and an essentially water soluble fiber free deproteininzed juice (DPJ) which is also described as brown juice. The juice fraction is sometimes treated to produce one green pigmented fraction that is also described as “chloroplastic protein” and the other cream colored fraction that is also described as “cytoplasmic protein”. For the purpose of this specification, all these basic fractions i.e. pulp, juice, fiber deproteinized juice, whole LPC, chloroplastic protein and cytoplasmic protein formed in conventional green crop process are termed as “primary fractions”.

GCF, as described above, has remained a framework within which work was done by N. W. Pirie in mid 1940s and onwards by his coworkers and students spread far and wide in several countries with an emphasis on use of LPC for human consumption. LPC has also been projected as an ingredient of poultry feed on account of its carotene and xanthophylls content. FR and DPJ have been projected for cattle feeding. GCF has been subject matter of U.S. Pat. Nos. 4,062,276, 3,975,546, 4,333,871, 4,421,682. Only instance of fiber being proposed for human feeding is from tender leaves of alfalfa as proposed by Xiong Shiyu in CN1478407 as good dietary fiber supplement for human consumption. However, selective defoliation of alfalfa is a laborious task in itself for the purpose of extraction of fiber from fresh leaves.

Above framework has been found inadequate to fully explore the potentials of GCF beyond production of LPC and cattle feeds and need was felt to explore further advancement into fractionation.

As a further advancement in this process, LPC and FR are fractionated further by using volatile organic solvents or caustic chemicals (U.S. Pat. No. 5,648,564, U.S. Pat. No. 4,048,203, U.S. Pat. No. 5,382,714) or by supercritical extraction (WO2007/056701A2, U.S. Pat. No. 6,737,552). However, solvent extraction strategies are limited by cost, and inevitability of solvent residues that remain in the product. Further, the isolates of the products, such as carotenes and xanthophylls themselves can not be used directly as such and need further transformation into absorbable and readily useable products.

A process that does not use hydrocarbon solvents and yet achieves as further fractionation of the primary fractions of GCF as possible shall be very useful to maximize the utilization of a green crop.

One such process U.S. Pat. No. 5,830,738 describes use of enzymes to digest fiber portion of crop that shall release cell content, which can be isolated. However, fiber is a major fraction, it shall be a voluminous task on a large scale manufacture to degrade all fiber enzymatically and that will also mean a loss of one product.

A simpler process that is more advanced in intent of fractionation achieved shall enable green crop to be used as raw material for recovery of several phytochemicals for more efficient utilization of green leafy vegetation crop.

Throughout this specification, a mention of a substance in singular also includes, unless context does not permit, plural of the same or same kind of one or more of a substance which can play same functional role. Thus, mention of “an oil” in the context of a solvent function also includes more than one oil and also any liquid that can play the same functions that the oil does in that context. Pointer of any claim basically is towards the function that is targeted to be achieved and not to the particular way in which it is to be achieved, unless specifically limited by express statement in the claim to that effect. Similarly, derivatives and functional alternatives that are obvious to a person skilled in the art or that come to knowledge as a result of practicing this invention as an obvious inference to a person skilled in the art with respect to the phytochemicals which can be produced from this invention are also included within the scope of this specification.

### SUMMARY OF INVENTION

The invention discloses new processes that expand the ability of the process of Green Crop Fractionation to fractionate or modify the primary fractions of green leafy vegetation crop to make new products.

For the purpose of this specification, “green crop” or “green plant” or “green leafy vegetation” are the terms used interchangeably to cover in their scope the said green plant comprising, at least one selected from the group comprising a green leafy vegetable, a green forage/fodder, a green leafy vegetation of a grain crop, a green leafy vegetation of a pulse crop including a bean crop, a green leafy vegetation of an oilseed crop, a green leafy by-product vegetation of root and tuber crops and cole crops and excludes plants which are not considered raw materials for green crop fractionation and are used exclusively as medicinal plants.

In one aspect of the invention, this invention discloses a process of oil extraction that results into compositions of phytochemicals or compositions containing at least one oil soluble phytochemcial as their ingredient; the said phytochemical is obtained by a process of fractionation of at least one comminuted part of at least one green plant, the said process of fractionation comprising extracting a comminuted whole green plant or a fraction of comminuted green plant, the plant being fresh or dry, or dried pulverized algae, by contacting with at least one oil, separating the oil extract and the residue. Phytochemicals indicative of oil soluble constituents comprise carotenes, xanthophylls, chlorophylls and oil soluble phenols. It is a further aspect of the invention that when oil extraction is done in small batches or with a solubility modifier such as common salt/table salt, and by varying relative proportion of oil used per batch, oil extracts of different relative concentrations of oil soluble phytochemicals are obtained. This gives a method to standardize process as well as compositions of oil extracts for various desired relative compositions useful for different applications. Since these extracts do not contain any solvent residues, depending on utility of the constituent phytochemicals for intended use, these extracts can either be directly used for human consumption after due standardized production or may be fractionated or purified further by known methods into constituent phytochemicals. The said known methods include chromatography, solvent fractionation and fractional crystallization. Oil extraction may be done with or without heating.

In another aspect of the invention, comminuted whole at least one green plant or a fraction of comminuted green crop the crop being fresh or dry, is extracted in hot as well as cold condition with an alkali or an acid that is dilute enough to ensure that protein in the fraction is only partially hydrolysed. This treatment is particularly applied to LPC and FR. After neutralization and separation of both the fractions, the extract is useful as a product high in polyphenols and acid or alkali solubles that get into solution from LPC or FR in the treatment; the extracted LPC is useful as high biological value protein concentrate and extracted FR gets automatically reduced to a fine powder. It is also a further aspect of invention that the acid extracted FR was seen to have reduced insoluble dietary fiber and increase in soluble fiber. In cold alkali treated fiber, no appreciable change in constitution was noted except a small decrease in soluble fiber.

A further embodiment of this invention provides advancement in GCF and includes preparing a new product as sub-fraction or a modified fraction of a primary fraction obtained in a process of green crop fractionation comprising steps of comminuting the fresh green vegetation, separating a moist fibrous fraction as one primary fraction from the another primary fraction juice and treating juice fraction to separate a primary water soluble deproteinized juice fraction that is high in water content from a primary water insoluble high protein low fiber fraction; the said fraction excluding (i) an extract of the said water insoluble high protein low fiber fraction by a volatile organic solvent, (ii) degradation products and enzymatic rearrangement products of the said insoluble high protein low fiber fraction, and (iii) a fraction obtained by supercritical extraction. In one aspect of this embodiment, fresh or dry green vegetation, except isolated leaves, is fractionated to obtain high fiber fraction which is made further microbiologically stable by a treatment including (a) removal of water or (b) by addition of an edible preservative, including common salt or (c) by sterilizing the same and packaging in a sterile condition. For this aspect, whole crop or defoliated stem portion of the crop can be used as starting material. In this embodiment, treatment of modification of a primary fraction can be done by oil extraction as described earlier, with or without using a solubility modifier such as common salt, with or without heating and using varying proportions of oil to achieve varying composition as desired. The said oil soluble constituents include at least a tocopherol, a carotene, a xanthophyll, a chlorophyll, a polyphenol, a phytosterol including isoflavone, a quinone or other oil solubles contained in the green plant material having solubility profile favorable for oil extraction.

In another embodiment, DPJ and water extracts of a green plant material prepared by heating treatment to remove protein by precipitation, are extracted with polar, partly polar or non-polar solvent to fractionate phytochemicals. Thus, total phenols in DPJ could be fractionated into hexane:dichloromethane (1:1) soluble fraction and aqueous fraction. The fraction of phenols soluble in hexane:dichloromethane fraction shall be phytosterols including isoflanones and quinones having strong anti-oxidant and therapeutic activity. Compositions of this invention made from green plant material derived from dried or fresh green crop, green crop fraction or dried algae comprises, (a) an oil extract, (b) residue remaining after oil extraction, (c) aqueous extract of residue remaining after oil extraction, (d) microbiologically stable aqueous extract, (e) microbiologically stable residue remaining after separating aqueous extract, (f) oil extract of an aqueous extract, (g) acid extract, (h) residue remaining after acid extraction, (i) alkali extract, (j) residue remaining after alkali extraction, (k) fibrous residue that is dried or treated under pressure of steam or sterilized.

It is an embodiment of this invention that fibrous residue left after removal of juice from pulped crop, which has been so far for last seven decades been considered as only fit for cattle consumption, was found surprisingly to be an extremely palatable dietary fiber supplement when it was (1) dried and powdered and added to fluid or near fluid food preparations such as dal and vegetable, or (2) when extracted with acid or alkali resulting in fine macerated powder. This preparation has about 50 to 60% insoluble fiber and about 0.5% soluble fiber in untreated state. The fiber can be treated with acid or alkali to extract phenols and the residue can also be used which gets automatically macerated during the next reaction process in finer particles. The acid or alkali extracted fiber has altered composition of insoluble and soluble fiber and depending on requirement, a suitable process can be chosen. It was seen that the fiber fraction can also be stored moist until used if common salt is added to saturate it preferably after a heat treatment. At the time of use, it can be used as such or after desalting Further, it was surprisingly found that immediately after incorporation of this fibrous residue, as a powder, in the recipe at a rate of about 3 to 5 grams per person, foul smell production in colon stopped, indicating promotion of favorable colon microflora. It was also further found that fiber has appreciable quantity of polyphenols

This invention may be practiced in a sequential extraction by employing various embodiments in a sequence and in combinations and on fractions of green plant material that maximizes fractionation or provides a new product or a product with new use. Choice of sequence and fractions to be chosen shall depend on the target compositions.

### DETAILED DESCRIPTION OF INVENTION

This invention, in general, provides new processes, provides new modifications, discloses unknown properties of fractions that results GCF as an expanded platform of a new and expanded range of composition available for human consumption with an expanded range of potential for pharmaceutical, neutraceutical and cosmaceutical products.

The compositions may themselves be usable directly for consumption, or serve as ingredients for compositions for pharmaceutical, neutraceutical or cosmaceutical applications, or may serve as food supplements or as additive to recipes.

FR and DPJ, which have so far been applied only for cattle consumption, are for the first time, made fit principally for human consumption. This invention embodies improved GCF that is capable of being used as a platform for preparing compositions enriched individually or in more useful combination of several phytochemicals available in green crop and improving utilization of green crop.

The green leafy vegetable, Fenugreek, (Trigonella foenum-graecum L.) known widely as Methi in India, has been used here to illustrate various embodiments of this invention. However, any plant species considered useful for GCF can be used in its place. The group from which a plant species for practicing various embodiments of this invention can be selected includes a green leafy vegetable, a green forage/fodder, a green leafy vegetation of a grain crop, a green leafy vegetation of a pulse crop including bean crop, a green leafy vegetation of an oilseed crop, a green leafy by-product vegetation of a root and tuber crop or cole crop and green leafy vegetation of tobacco when tobacco is intended to be prepared from fibrous residue separated from comminuted leaves. Plant species that are used at present exclusively for production of herbal medicines are excluded from the scope claims of this patent.

Some of the embodiments of this invention are adaptable to fresh or dry whole crop, to pulp of a fresh crop and to dry pulverized powder of algae such as Spirulina; and are included within the scope of claims of this invention.

Many other analogous variations would be obvious to a person skilled in the art and are also included within the scope of the claims of this invention.

The compositions of this invention further includes compositions and dosage forms useful in pharmaceuticals, neutraceutical treatments and cosmetics containing the phytochemical fractions of this invention as at least one ingredient.

In the following are described and discussed several examples of embodiments of this invention. The examples fully illustrate the principle of the embodiment and the conditions used have a scope for further improvement, fine tuning, modification to achieve better recovery of phytochemicals in the fractions of the embodiment and for achieving better yield of the fractions themselves from the raw green plant material. When per ton of fresh vegetation is the expression used, it includes roots also, as the crop is marketed with roots. Roots were cut and discarded in this work, although in commercial production, they may be retained. Shoots to roots ratio usually showed a distribution of about 1:0.4 in mature to 1:0.23 on wet weight basis in young crop of Trigonella sp.

In one embodiment of this invention, sub-fractionation of a primary fraction referred above is done by contacting the same with an oil, preferably an edible oil, with or without application of heat, with or without addition of an agent, preferably common salt, that modifies solubility of chemical constituents of the green plant material into the oil and separating the oil fraction from the extracted residue and using both fractions as such or after further fractionation for human consumption. Sesame oil was added to moist FR, after allowed to stand overnight separated through cloth by hand pressing. Results obtained in illustration of this embodiment are given in table 1:

TABLE 1
Fractionation of dry vegetation powder and moist FR and LPC by Oil

| | Oil extraction from dry | | | | | |
|---|---|---|---|---|---|---|
| | powder of shoots | | Oil extraction of FR | | Oil extraction of LPC | |
| | 1st | 2nd | 1st | 2^{nd} | 1^{st} | 2nd |
| | extract | extract | extract | extract | extract | extract |
| Oil used (kg) in | 1440 | 3024 | 324 | 369 | 324 | 270 |
| extraction for | | | | | | |
| fraction from 1 | | | | | | |
| ton vegetation | | | | | | |
| Carotenes | 48.44 | 14.74 | 6.02 | 11.28 | 28 | 18.56 |
| mg/kg oil | | | | | | |
| Xanthophylls | 79.72 | 12.58 | 8.75 | 8.03 | 95 | 221.61 |
| mg/kg oil | | | | | | |
| Chlorophylls | 16.70 | 19.70 | 10.38 | 0.63 | 183.82 | 42.32 |
| mg/kg oil | | | | | | |
| Carotene | 69756 | 39798 | 1950 | 3042 | 9072 | 6848 |
| (mg) in 1 ton | | | | | | |
| vegetation | | | | | | |
| Xanthophylls | 114796 | 33966 | 2805 | 2188 | 30780 | 8343 |
| (mg) in 1 ton | | | | | | |
| vegetation | | | | | | |
| Chlorophylls | 4809 | 10638 | 3363 | 170 | 59588 | 15616 |
| (mg) in 1 ton | | | | | | |
| vegetation | | | | | | |

Edible oil from any other source could also have been used in place of sesame oil. First oil extraction was done without addition of salt and second was done after addition of salt to a level above saturation of water of the LPC composition. In view of the fact that this oil component shall also contain many other oil solubles mentioned above, some of which including alpha tocopherol shall provide protection against oxidation. Oil extracts attain a very useful embodiment of this invention as oil extract does not contain any solvent residues and can be used as such for human consumption, or as an ingredient in other compositions or can optionally be fractionated further by any known or inventive processes. The possibility of using this fraction directly without the need of further processing, such as a need to make absorbable solution. makes this embodiment advantageous over all processes base on extraction by volatile organic solvents or by supercritical extraction Freeness from solvent residues is a distinct advantage over any process that involves use of volatile organic solvents.

Oil extract could also be prepared from dry plant powder by contacting the same with sesame oil overnight followed by another sequential extraction. To the residue water was added and salt was added to super saturate and more oil was added and mixed well. As mixture failed to separate oil it was desalted with water. and more oil was added and heated in a boiling water bath to break the emulsion and oil layer separated. It was also interesting that relative proportions of extraction of non-polar and polar constituents changed in serial extractions. This gives an excellent basis for selective elution, if desired. The aqueous salt wash contained polyphenols that could be extrapolated to 3662 g of polyphenols per ton of dry vegetation. The wash can be concentrated and desalted to work as polyphenols rich product.

Oil extracts were also prepared form dry powdered algae. Tablets available in market containing 400 mg of Spirulina per tablet with other ingredients (each tablet contains 400 mg sprulina, 100 mg processed black pepper and 100 mg amla. Manufactured in India by Alintosch Pharmaceuticals Ltd, Baidyanath House, 20, Great Nag Road Nagpur 440009) were used. Tablets were powdered and extracted overnight with oil. Extraction was extrapolated for every ton of powdered Spirulina to give a yield of 33 mg of carotene, 757 mg of xanthophylls and 468 mg of chlorophyll. This shows very low content in this composition. It is very likely that the preparation was stored for a long time. However, this showed that oil extraction of this invention can be adapted to algae too and oil extracts of dried algae would give phytochemical containing compositions.

In one method of extraction, moist LPC cake (35.35% dry matter) was extracted with oil in 1:2 (W/V) proportion in cold (room temperature of about 20 to 25 degrees Celcius) and hot conditions (30 minutes in boiling water bath) without and with additions of salt, the salt being added to super saturate before additions of oil and mixed thoroughly. Results are given in Table 2:

TABLE 2
Oil extraction from moist LPC in cold and accompanied by heating

| | LPC | | FR | |
|---|---|---|---|---|
| | Cold | Hot | Cold | Hot |
| | Extraction without salt addition | | | |
| Carotenes mg/kg oil | 164 | 151 | 4.117 | 10 |
| Xanthophylls mg/kg | 309 | 257 | 6.41 | 7.9 |
| oil | | | | |
| Carotene (g) in 1 ton | 10.05 | 9.25 | 0.58 | 1.4 |
| vegetation | | | | |
| Xanthophylls (g) in 1 | 18.93 | 19.75 | 0.9 | 1.11 |
| ton vegetation | | | | |
| | Fractionation with oil | | | |
| | with salt addition | | | |
| Carotenes mg/kg oil | 162 | 41 | | |
| Xanthophylls mg/kg | 21 | 37 | | |
| oil | | | | |
| Carotene (g) in 1 ton | 20.6 | 5.21 | | |
| vegetation | | | | |
| Xanthophylls (g) in 1 | 2.67 | 4.7 | | |
| ton vegetation | | | | |

Thus, oil extraction method seems to be an efficient one, and repeat extractions will give further recoveries, although hot extraction seems to be adverse in general.

In another method of extraction by oil, moist LPC desiccated to make it a free flowing powder was filled in a column, oil was passed through it and collected at bottom. Three fractions, each being equal to void volume, were collected serially. For fourth elution, more residence time of the oil in the column was permitted by stopping the flow and collected later. All fractions were analyzed for carotenes, xanthophylls and chlorophylls. Results are given in Table 3:

TABLE 3
Fractionation by oil extraction by passing
oil through a column of moist LPC

| | 1st | 2nd | 3rd | 4th |
|---|---|---|---|---|
| | fraction | fraction | fraction | fraction |
| Oil used (kg) in | 19.2 | 12.9 | 15.4 | 15.4 |
| extraction for | | | | |
| fraction from 1 | | | | |
| ton vegetation | | | | |
| Carotenes | 321 | 142 | 37 | 90 |
| mg/kg oil | | | | |
| Xanthophylls | 630 | 453 | 97 | 168 |
| mg/kg oil | | | | |
| Chlorophylls | 1585 | 1638 | 13 | 8 |
| mg/kg oil | | | | |
| Carotene | 5503 | 2486 | 639 | 1534 |
| (mg) in 1 ton | | | | |
| vegetation | | | | |
| Xanthophylls | 10800 | 7766 | 1486 | 2879 |
| (mg) in 1 ton | | | | |
| vegetation | | | | |
| Chlorophylls | 27171 | 28080 | 217 | 129 |
| (mg) in 1 ton | | | | |
| vegetation | | | | |

Total extraction achieved per ton of vegetation was 10 g carotenes, 23 g xanthophylls and 56 g chlorophylls. The experiment showed that while more elution shall lead to improve recovery, it would be useful to allow a longer residence time every time bed volume was filled up and then go for next batch of extraction.

Phenols is another important phytochemical in itself and is indicator of ability to fractionate other phytochemicals with similar solubility characteristics.

Total phenols excluding fraction soluble in Hexane:Dichloromethane taken in 1:1 proportion (H:D 1:1) were determined for LP, FR and DPJ prepared without and with addition of 350 g ascorbic acid per ton vegetation at the time of pulping. The results are given in Table 4:

TABLE 4
Total phenols insoluble in Hexane:Dichloromethane

| | | | | Vegetation treated with | | |
|---|---|---|---|---|---|---|
| | Vegetation not treated | | | 350 g ascorbic acid per | | |
| | with ascorbic acid | | | ton vegetation | | |
| | LP | FR | DPJ | LP | FR | DPJ |
| Total | 5762 | 4705 | 4218 | 7585 | 4082 | 5172 |
| Polyphenol | | | | | | |
| mg/kg | | | | | | |
| Polyphenol | 70 | 302 | 19 | 96 | 262 | 26 |
| (mg) in the | | | | | | |
| fraction per | | | | | | |
| ton of | | | | | | |
| vegetation (g) | | | | | | |

It was, however, found that contrary to expectations, all these fractions had significant quantity of H:D soluble phenols. Phenols from the fraction could be extracted by heating with 2 N HCl, neutralization with NaOH and extracting neutralized extract with H:D mixture. Results obtained are given in Table 5:

TABLE 5
Fractionation of total phenols in Hexane:Dichlorometahne
H:D soluble and aqueous fraction: The LPC was taken after
one oil extraction, hence some H:D soluble phenols may
have been already got extracted in oil extract.

| | Vegetation not treated | | | Vegetation treated | | |
|---|---|---|---|---|---|---|
| | with ascorbic acid | | | with ascorbic acid | | |
| | LPC | DPJ | FR | LPC | DPJ | FR |
| Phenols mg/kg in | 662 | 214 | 1004 | 712 | 187 | 585 |
| H:D soluble | | | | | | |
| fraction | | | | | | |
| Phenols mg/kg in | 2861 | 4545 | 3226 | 1842 | 6407 | 3046 |
| H:D insoluble | | | | | | |
| (aqueous) | | | | | | |
| fraction | | | | | | |
| Phenols (g) from | 38 | 13 | 65 | 61 | 17 | 38 |
| this fraction in 1 | | | | | | |
| ton vegetation | | | | | | |
| Phenols (g) from | 163 | 276 | 207 | 158 | 577 | 196 |
| this fraction in 1 | | | | | | |
| ton vegetation | | | | | | |

Removing salt formed by neutralization may take these extracts, H:D extract as well as aqueous extract to a high content with respect to phenols. It is also possible that the neutralized acid extract is not further fractionated and used, after desalting, preferably by dialysis, as high phenol fraction.

In one experiment, DPJ was fractionated sequentially by extraction by oil first without salt addition, followed by second extraction after addition of salt to saturation and the aqueous residue was obtained after recovery of second oil extract. Results of this fractionation are as given in Table 6:

TABLE 6
Fractionation of polyphenols in DPJ

| | Oil extract | Second oil extract | Residual aqueous |
|---|---|---|---|
| | without salt | taken after salt | extract in salt |
| | addition | addition | saturated fraction |
| Polyphenols | 385 | 96 | 417 |
| mg/kg oil | | | |
| Polyphenols (g) | 58 | 14 | 676 |
| per ton | | | |
| vegetation in the | | | |
| fractions | | | |

A salt water extraction of dry powdered vegetation yielded extract containing polyphenols of about 3662 g/ton of dry powder.

Acid extraction at boiling water bath temperature for 30 minutes and neutralization with NaOH yielded extraction of 63 g/ton of vegetation from FR and 53 g/ton of vegetation from LPC. Getting this fraction shall be practical when FR is treated for the purpose of improving its soluble fiber content. This treatment given to LPC will on one hand may result in partial digestion yielding protein compositions of high biological value and make residual protein also better digestible.

Phenols from DPJ were also recovered as product by ethyl acetate extraction. This resulted in a product, which showed 8487 mg/kg phenols. This extract also had H:D soluble and aqueous phenols, which extrapolated to H:D soluble phenols 12 g and aqueous phenols 343 g per ton of vegetation.

Polyphenols are particularly important from the point of view of a concept of Oxygen Radical Absorbance Capacity as a determinant of anti-oxidant capacity of food supplements. Fractions of this invention rich in polyphenols may be important from that point of view too. Some of then may also be isoflavonoids, phytosterols and other phytohormones, which are important for their therapeutic properties.

Thus, carotenes, xanthophylls, chlorophylls and phenols and other phytochemicals having similar solubility characteristics as these phytochemicals can be obtained as oil fractions from green plant materials including algae including fresh or dry green vegetation, LPC, FR and dry powdered algae. Ratio of constituents extracted may be determined by initial ratio of the same available in the fraction taken for extraction, by quantity of oil added relative to the fraction, the serial number of extraction and by presence or absence of a solubility modifier like salt. This results into compositions with differing relative proportion of oil solubles. In addition to above named constituents in this paragraph, an oil extract or a H:D extract or an ethyl acetate extract shall also contain in it all other oil soluble constituents present in the green plant material subjected to extraction by these solvents, including, but not limited to, tocopherols, fats and oils of green vegetation including saturated fat including palmitic oil, polyunsaturated fat including linolenic acid and the omega 3 polyunsaturated fat alpha linolenic acid, oil soluble phenols such as phytosterols and isoflavones, oil soluble or H:D soluble quionones such as Coenzyme Q, chlorophylls and other phytochemicals present in the green plant material having solubility profile similar to the phytochemical listed above. By further fine tuning of variables of this embodiment, it would be possible to produce a wide variety of oil extracts fine tuned to be efficacious to specialized and focused applications to maximize utilization of the phytochemical constituent/s of the green plant material.

In another embodiment of this invention, it has been surprisingly found that the fibrous fraction has been found to be very much palatable as dietary fiber supplement for human consumption. In one aspect of this embodiment, the fibrous residue is preserved moist by adding table salt above saturation point or by removing moisture to air dry level of less than about 15%. This fraction may also be given steam treatment under pressure, alkaline treatment or acid treatment with or without separation of resulting aqueous digest after neutralization and use of the aqueous digests as source of polyphenols, quinones and the like. The said aqueous extracts may be further fractionated by membrane separation or by oil extraction in fractions containing different compositions for different applications. FR as such after drying and powdering without any further treatment showed, on dry matter basis insoluble fiber about 65% and soluble fiber of about 0.45% where soluble fiber is only about 0.6% of the insoluble fiber. When extracted with 2N HCl for polyphenols fraction, the resulting fibrous residue remaining after separating the extract showed soluble fiber to be about 36% of the insoluble fiber. Thus this new product is not just a bulk providing material but shall also provide all properties provided by soluble fiber including supporting growth of bacteria in colon and reduction in cholesterol. This product is better balanced as dietary fiber than the untreated FR. It was also found that the immediate utility of addition of untreated fibrous residue to recepies to provide around 2 gram per person per day of the air dry fibrous residue (about 10% moisture) resulted in disappearance of generation of gases with foul smell. Acid extracted fibrous residue also may have same properties. Powder of treated as well as acid extracted FR can also be useful as an ingredient of a high-fiber drink, high fiber biscuits, high fiber cookies and the like.

Residual oil from a residue left after oil extraction may be facilitated by dropping the residue to hot water, removing the hot water, washing the residue with more hot water washes, combining all hot water washes and recovering oil layer from the water washes. In yet another embodiment of this invention, the deproteinized juice is concentrated to a microbiologically stable syrup level and used as such as or after further fractionation as flavourant, or an ingredient of a drink containing water soluble phytochemicals in effective amount for their applications for human beings. This fraction may also be further fractionated into fractions rich in or as isolates of phytochemicals having therapeutic or cosmetics uses, said phytochemicals including polyphenols, phytohormones, flavonols, minerals and the like. Such fractions may be oil extracts that shall contain actives soluble in oil including polyphenols, quinines, sterols, phytohormones and the like, and aqueous extract remaining after oil extraction that shall contain oil insoluble actives including polyphenols.

Embodiments of this invention also includes adaptation of the novel methods of oil extraction and dilute acid treatment to entire crop itself after or during comminuting.

Embodiments of this invention also include compositions in which the fractions of this invention are added as an ingredient; the said compositions being applicable for pharmaceutical, nutritional or cosmetics applications that may contain one or more of an additional ingredient. The said additional ingredient may, without limitation, be another active ingredient, an excipient, a filler, a binder, a sweetener, a coloring matter, or an inert substance.

For steps such as concentration or salt removal, processes such as reverse osmosis and dialysis may also be used as applicable.

This invention may be practiced in a sequential extraction by employing various embodiments in a sequence and in combinations and on fractions of green plant material that maximizes fractionation or provides a new product or a product with new use. Choice of sequence and fractions to be chosen shall depend on the target compositions. Carotenes and xanthophylls were analyzed using method described by Knowles, Livingston and Kohler (1972) (AGRICULTURAL AND FOOD CHEMISTRY, Vol 20, No. 6, pp. 1127 for dried plant materials and by Knuckles, Bickoff and Kohler, (1972) (JOURNAL OF THE AOAC, vol 55, No. 6, pp. 1202). For oil samples, about 0.25 g was dissolved in 5 ml ethanol and subjected to further method as described in Knuckles et al (1972).

For determination of phenols, sample was extracted in Hexane:Dichloromethane (H:D) (1:1), H:D extract was evaporated under flow of nitrogen to dryness, dissolved in acetone and 0.5 ml that was taken for determination was made to 8 ml with water, 0.5 ml Folin-Ciocalteu reagent was added, mixed well, after 3 minutes 1 ml saturated sodium chloride solution was added and color was read on spectrophotometer at 725 nm. Gallic acid was used as standard.

Dietary fibers were determined by gravimetric method as described in IS 11060: Indian Standards Institution, (1985), Manak Bhavan, 9 Bahadurshah Zafar Marg, New Delhi 110002, India.

Total chlorophyll was determined on 85% acetone extract of the sample ground in acetone in presence of a small amount of calcium or magnesium carbonate, decanting the acetone and repeating extraction until residue is colorless, filtering the extract accompanied by washing the filter paper, pooling the extracts and making to a volume, pipetting 25 to 50 ml of acetone extract to 50 ml ether in a separating funnel, adding water from sides of the separating funnel until water layer is apparently free of all fat-soluble pigments, draining off water layer, washing ether layer 5 to 10 times with 10 ml portions of distilled water or until ether layer is free of acetone, transferring to 100 ml volumetric flask, diluting to volume with ether and mixing. The solution is transferred to amber colored bottle and 3 to 5 gram anhydrous sodium sulfate is added. After the solution clears off, the solution is pipetted into another dry bottle and diluted with ether such that the OD of the color at 660 nm is between 0.2 to 0.8.

OD was read at 660 nm and 642.5 nm and total chlorophyll calculated by substituting the reading in the equation:

Total chlorophyll, mg/liter=(7.12×OD at 660 nm)+(16.8×OD at 642.5 nm)

1. A composition comprising at least one phytochemical ingredient, the said phytochemical ingredient being obtained by a process of fractionation of at least one green plant material derived from dried or fresh green crop, green crop fractions or dried algae; the said green crop being at least one selected from the group comprising a green leafy vegetable, a green forage/fodder, a green leafy vegetation of a grain crop, a green leafy vegetation of a pulse crop including beans, a green leafy vegetation of an oilseed crop, a green leafy by-product vegetation of a root and tuber crop or a cole crop, green leafy vegetation of tobacco; and the said process of fractionation comprising any one or a combination of following steps:
a. extracting the said green plant material by contacting with at least one oil, preferably an edible oil, with or without heating, separating the oil extract and the residue,
b. extracting the said green plant material, for a period of time, with or without heating, by contacting with an alkali or an acid under conditions that may or may not result in partial degradation of proteins, neutralizing and separating the liquid extract fraction and the residue fraction as products with or without further treatment, modification or further fractionation,
c. further fractionating or modifying a primary fraction obtained in a process of green crop fractionation or a sub-fraction of the said primary fraction; the said primary fraction being a product of a green crop fractionation process comprising steps of comminuting the fresh green plant material, separating a moist fibrous fraction as one primary fraction from the juice as another primary fraction and treating juice fraction to separate a primary water soluble deproteinized juice fraction that is high in water content from a primary water insoluble high protein low fiber fraction; the said—further fractionation excluding (i) extracting the said water insoluble high protein low fiber fraction by a volatile organic solvent, (ii) use of polypropylene glycol in the extraction, (iii) degradation products and enzymatic rearrangement products of the said insoluble high protein low fiber fraction, and (iv) use of supercritical extraction.

2. A composition of claim 1 prepared by comminuting the said fresh or dried green plant material, followed by fractionation of the said green plant material into at least one high fiber fraction and at least one low fiber fraction, making the said high fiber fraction microbiologically stable by a treatment, including without limitation, (a) removal of water to an extent that makes it microbiologically stable or (b) addition of an edible preservative, including common salt, in an amount that makes it microbiologically stable, or (c) sterilizing the same and packaging in a sterile condition to make it microbiologically stable.

3. A composition of claim 1 prepared by a process comprising (a) bringing comminuted fresh or dried green plant material or at least one primary fraction of a green crop or a sub-fraction of a primary fraction with at least one oil, preferably an edible oil, with or without heating, the said oil taken in a volume and for a period of time to effect transfer of oil solubles from the said primary fraction to the oil and (b) separation of extracted plant material from oil extract, optionally repeating oil extraction step few more times and pooling the oil extracts; the primary fraction being, without limitation, at least one primary fraction selected from the group comprising the said juice fraction, the said moist fibrous fraction, and the said water soluble deproteinized juice fraction

4. A composition of claim 3 wherein:
a. an agent capable of modifying solubility of oil soluble constituents, with or without application of heat, is added before addition of oil, or with addition of oil or after addition of oil in an amount that results into differential transfer of oil soluble constituents from the said fractions to the added oil, preferably the said agent being a salt more preferably sodium chloride added in an amount that results in near saturation or in an amount that is in excess of salt required to saturate water content of the said green plant material subjected to oil extraction or/and
b. oil is used in such a relative proportions for extraction that every extraction gives a different relative composition of oil soluble constituents, the said oil soluble constituents at least including, without limitation, tocopherols, carotenes, xanthophylls, chlorophylls, polyphenols, phytosterols including isoflavones and quinones including Coenzyme Q.

5. A composition of claim 3 wherein the said comminuted plant or plant fraction is contacted with at least one oil and either:
a. mixed and after completion of contact period, separated by pressing through a membrane, including a cloth, or
b. mixed and after completion of contact period separated centrifugally, or
c. the said comminuted plant or plant fraction is filled in a column as a bed and oil passed through it until major portion of oil solubles are extracted in the effluent, or
d. extracted in oil by a process involving solvent partitioning comprising countercurrent extraction or phase separation.

6. A composition of claim 1 (b) wherein the said extraction is made by using hydrochloric acid or sodium hydroxide, with or without heating, and the material taken for extraction being preferably a comminuted dry powder of a plant or a plant fraction or at least one primary fraction selected from the group comprising, without limitation, the said juice fraction, the said wet fibrous fraction, the said water soluble deproteinized juice fraction and the said water insoluble high protein low fiber fraction.

7. A composition of claim 1 prepared from green plant material by a process of extraction using a polar, partly polar or non-polar solvent or a mixture thereof, where the said fraction is at least, without limitations, one from the following: water soluble deproteinized juice fraction or its sub-fraction, water extract of water insoluble high protein low fiber fraction; the solvent used preferably comprises at least methanol, ethyl acetate, hexane, dichloromethane or mixture thereof.

8. A composition comprising at least one phytochemical obtained from green plant material derived from dried or fresh green crop, green crop fraction or dried algae; the said green crop being at least one selected from the group comprising a leafy vegetable of a forage/fodder, a grain crop, a pulse crop including a bean crop, an oilseed crop, a by-product vegetation of root and a tuber crop or cole crop, and tobacco; the said composition comprising, without limitations, at least one of the following: (a) oil extract, (b) residue remaining after oil extraction, (c) aqueous extract of residue remaining after oil extraction, (d) microbiologically stable aqueous extract, (e) microbiologically stable residue remaining after separating aqueous extract, (f) oil extract of an aqueous extract, (g) acid extract, (h) residue remaining after acid extraction, (i) alkali extract, (j) residue remaining after alkali extraction, (k) fibrous residue that is dried or treated under pressure of steam and sterilized or treated with acid or alkali, or preserved with salt, (l) an extract containing at least a phenol or/and a quinone.

9. A method of using at least one composition of claim 1 as a source of natural products, where:
a. an oil extract is used as an enriched source of at least one oil soluble natural compound contained in green plant material having oil solubility profile similar to that of phytochemicals of and including tocopherols, carotenes, chlorophylls, saturated fats including palmitic acid, polyunsaturated fats including linolenic and alpha linolenic acid, chlorophylls, isoflavones, quinones including co-enzyme Q,
b. residue remaining after extraction with oil is used as an enriched source of at least one oil insoluble natural compound or component of green plant material that is oil insoluble as well as water insoluble including high biological value dietary protein, or dietary fiber,
c. residue remaining after extraction with oil is used as an enriched source of at least one oil insoluble natural compound of green plant material that is oil insoluble and water soluble phytochemical that has solubility properties similar to that of and including polyphenols,
d. aqueous acid or aqueous alkali extract of residue remaining after oil extraction is used as enriched source of at least one oil insoluble and water soluble phytochemical that has solubility properties similar to that of and including polyphenols,
e. residue remaining after aqueous acid or aqueous alkali extraction is used as at least one water insoluble residue of green plant material enriched in at least one water insoluble constituent including fiber, dietary protein and minerals,
f. microbiologically stable unfractionated deproteinized juice is used as dietary supplement or a component of a drink,
g. microbiologically stable fibrous residue, unfractionated or residue remaining after further fractionation, is used for human consumption as dietary fiber or otherwise,
h. oil extract of an aqueous extract used as enriched source of at least one water soluble as well as oil soluble phytochemical of green plant material having solubility properties similar to that of and including oil soluble phenols including phytohormones and oil soluble quinones,
i. fibrous residue that is dried or treated under pressure of steam and sterilized or preserved with a preservative preferably by using salt as preservative, used as a source of dietary fiber.

10. Composition of claim 1 containing at least one phytochemical ingredient and at least one more ingredient, that includes, without limitation, another active ingredient, an excipient, a filler, a binder, a sweetener, a coloring matter, or an inert substance.

11. A composition of claim 4 wherein the said comminuted plant or plant fraction is contacted with at least one oil and either:
a. mixed and after completion of contact period, separated by pressing through a membrane, including a cloth, or
b. mixed and after completion of contact period separated centrifugally, or
c. the said comminuted plant or plant fraction is filled in a column as a bed and oil passed through it until major portion of oil solubles are extracted in the effluent, or
d. extracted in oil by a process involving solvent partitioning comprising countercurrent extraction or phase separation.
